(19) United States
(12) Patent Application Publication
(10) Pub. No.: US 2026/0141549 A1
(43) Pub. Date: May 21, 2026

(54) PROCESSING IMAGE DATA

(71) Applicant: QUALCOMM Incorporated, San Diego, CA (US)

(72) Inventors: Martin JIRENIUS, Linköping (SE); Mattias EVENSSON, Linköping (SE)

(21) Appl. No.: 18/949,855

(22) Filed: Nov. 15, 2024

(51) Int. Cl. G06T 7/593; B60W 60/00

(52) U.S. Cl. CPC G06T 7/593; B60W 60/001; G06T 2207/30252

(57) ABSTRACT

Systems and techniques are described herein for processing image data. For instance, a method for processing image data is provided. The method may include determining epipolar lines of an input image based on an epipole point of the input image; sampling pixels of the input image based on the epipolar lines to obtain pixels for rows of a rectified image; causing pixels of rows in the input image to align in columns in the rectified image; and outputting the rectified image.

### TECHNICAL FIELD

The present disclosure generally relates to image data. For example, aspects of the present disclosure include systems and techniques for processing image data.

### BACKGROUND

In automotive applications, depth sensing plays a role in autonomous driving, collision avoidance, and other advanced driver assistance systems (ADAS). Depth sensing may involve determining a distance between a vehicle and points in a scene (e.g., points on the road ahead of the vehicle). A computing system of a vehicle may determine depths to points in the scene (e.g., using three-dimensional triangulation) based on images captured from different points in the scene.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing image data. According to at least one example, a method is provided for processing image data. The method includes: determining epipolar lines of an input image based on an epipole point of the input image; sampling pixels of the input image based on the epipolar lines to obtain pixels for rows of a rectified image; causing pixels of rows in the input image to align in columns in the rectified image; and outputting the rectified image.

In another example, an apparatus for processing image data is provided that includes at least one memory and at least one processor (e.g., configured in circuitry) coupled to the at least one memory. The at least one processor configured to: determine epipolar lines of an input image based on an epipole point of the input image; sample pixels of the input image based on the epipolar lines to obtain pixels for rows of a rectified image; cause pixels of rows in the input image to align in columns in the rectified image; and output the rectified image.

In another example, a non-transitory computer-readable medium is provided that has stored thereon instructions that, when executed by one or more processors, cause the one or more processors to: determine epipolar lines of an input image based on an epipole point of the input image; sample pixels of the input image based on the epipolar lines to obtain pixels for rows of a rectified image; cause pixels of rows in the input image to align in columns in the rectified image; and output the rectified image.

In another example, an apparatus for processing image data is provided. The apparatus includes: means for determining epipolar lines of an input image based on an epipole point of the input image; means for sampling pixels of the input image based on the epipolar lines to obtain pixels for rows of a rectified image; means for causing pixels of rows in the input image to align in columns in the rectified image; and means for outputting the rectified image.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 includes an example image that may be captured by a camera of a vehicle, an example of a rectified version of the image, and an example disparity map that may be generated based on the rectified version of the image;

FIG. 2 is a diagram of an example system in which a camera of a vehicle may capture images of a scene from different positions;

FIG. 3 illustrates two example images that may be used to determine depth information according to a depth-from-stereo (DFS) depth-estimation technique;

FIG. 4 illustrates two example images and an example associated cost function, according to various aspects of the present disclosure;

FIG. 5 includes an example image overlaid with epipolar lines and an example rectified image overlaid with lines to indicate rows;

FIG. 6 includes an example image and an example rectified image to provide context for a description of polar epipolar rectification;

FIG. 7 includes an example rectified image overlaid with annotations to indicate flaws introduced by conventional polar epipolar rectification;

FIG. 8 includes an example image and an example rectified image to illustrate distortions caused by conventional polar epipolar rectification;

FIG. 9 includes an example image and an example rectified image (e.g., rectified according to various aspects of the present disclosure) to illustrate corrections based on the distance-alignment technique;

FIG. 10 includes an example rectified image (e.g., rectified according to conventional polar epipolar rectification) and an example rectified image (e.g., rectified according to the distance-alignment technique) to illustrate how the distance-alignment technique corrects a flaw of conventional polar epipolar rectification;

FIG. 11 includes an example image and an example rectified image (e.g., rectified according to conventional polar epipolar rectification) to illustrate distortions caused by conventional polar epipolar rectification;

FIG. 12 includes an example input image overlaid with epipolar lines (e.g., determined according to a conventional polar epipolar rectification) and an example rectified image overlaid with lines indicating rows corresponding to epipolar lines;

FIG. 13 includes an example image overlaid with epipolar lines (e.g., determined according to an angle-step technique of the present disclosure) and an example rectified image overlaid with lines indicating rows corresponding to epipolar lines;

FIG. 14 includes an example rectified image (e.g., rectified according to conventional polar epipolar rectification) and an example rectified image (e.g., rectified according to the angle-step technique of the present disclosure) to illustrate how the angle-step technique corrects a flaw of conventional polar epipolar rectification;

FIG. 15 includes an example input image and an example rectified image (e.g., rectified according to conventional polar epipolar rectification) to illustrate distortions caused by conventional polar epipolar rectification;

FIG. 16 includes an example input image and an example rectified image (e.g., rectified according to conventional polar epipolar rectification);

FIG. 17 includes an example image overlaid with an example epipolar line (which may be sampled, according to various aspects of the present disclosure) and an example rectified image overlaid with a line indicating a row corresponding to the example epipolar lines;

FIG. 18 includes a graph illustrating an example Bezier function that may be used to determine pixels to sample along ah epipolar line, according to various aspects of the present disclosure;

FIG. 19 includes an example rectified image (e.g., rectified according to conventional polar epipolar rectification) and an example rectified image (e.g., rectified according to the radius-sampling technique, according to various aspects of the present disclosure) to illustrate how the radius-sampling technique corrects a flaw of conventional polar epipolar rectification;

FIG. 20 includes an example rectified image (e.g., rectified according to conventional polar epipolar rectification) and an example rectified image (e.g., rectified according to various aspects of the present disclosure);

FIG. 21 includes an example disparity map (which may be generated based on two images rectified according to conventional polar epipolar rectification) and an example disparity map 2112 (which may be based on two images rectified according to various aspects of the present disclosure);

FIG. 22A is a block diagram illustrating an example system 2210 for processing image data, in accordance with aspects of the present disclosure.

FIG. 22B is a flow diagram illustrating an example process for processing image data, in accordance with aspects of the present disclosure;

FIG. 23 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned previously, in automotive applications, depth sensing plays a role in autonomous driving, collision avoidance, and other advanced driver assistance systems (ADAS). Depth sensing may involve determining a distance between a vehicle and points in a scene (e.g., points on the road ahead of the vehicle). A computing system of a vehicle may determine depths to points in the scene (e.g., using three-dimensional triangulation) based on images captured from different points in the scene.

Polar epipolar rectification is a technique that estimates depth from mono/stereo vision (e.g., images captured by a camera at two different times and used as a stereoscopic pair) using the apparent motion of the vehicle. Polar epipolar rectification may involve: 1) determining an epipole point in an input image; 2) sampling pixels along epipolar lines from the epipole point to edges of the input image to obtain pixels for corresponding columns of a rectified image; 3) determining disparities between pixels of the rectified image and pixels of another rectified image by comparing pixels along respective rows of the rectified images; and 4) determining depths to points in the scene based on the disparities. Polar epipolar rectification may generate a disparity map which can be used to detect vertical objects protruding from the road surface. Polar epipolar rectification is described by IPOL Journal, The Polar Epipolar Rectification by Darmon, François and Pascal Monasse. Image processing on line 11 (2021): 56-75.

Polar epipolar rectification provides a way to process images from arbitrary pinhole camera systems but introduces some drawbacks for automotive use cases. For example, polar epipolar rectification introduces the following flaws into rectified images: 1) polar epipolar rectification produces heavily distorted images which makes it inefficient to search for vertical gradients in the depth map; 2) the ego lane (e.g., the lane in which the vehicle is travelling) will be overrepresented in images rectified according to polar epipolar rectification, this results in loss of crucial information in neighboring lanes; and 3) images rectified according to polar epipolar rectification includes a disproportionate number of samples near the vehicle, this makes it even more difficult to calculate the depth to points distant from the vehicle.

Systems, apparatuses, methods (also referred to as processes), and computer-readable media (collectively referred to herein as “systems and techniques”) are described herein for processing image data. For example, the systems and techniques described herein may address the issues of polar epipolar rectification. The systems and techniques may produce more accurate depth maps in difficult areas and thus enable ADAS to detect objects both farther away and farther to the side of a vehicle.

Various aspects of the application will be described with respect to the figures below.

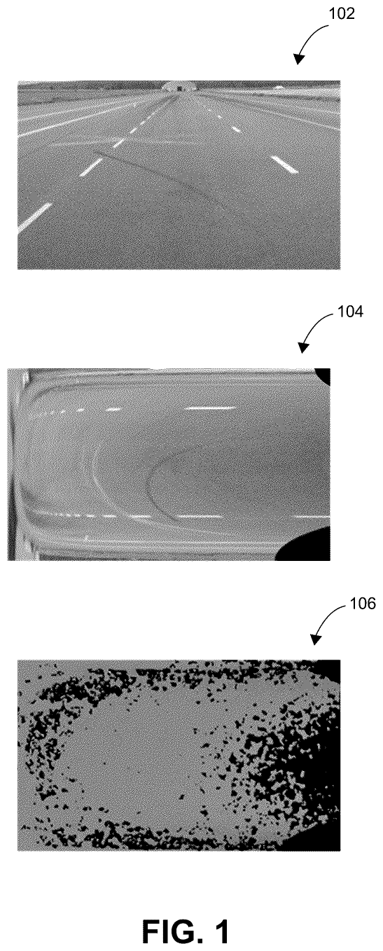

FIG. 1 includes an example image 102 that may be captured by a camera of a vehicle. Additionally, FIG. 1 includes an example rectified image 104. For example, rectified image 104 may be image 102 after image 102 has been rectified according to a conventional polar epipolar rectification. Additionally, FIG. 1 includes an example of a disparity map 106 that may be determined based on rectified image 104.

A camera of a vehicle may obtain image 102. A computing system of a vehicle may rectify image 102, according to a conventional polar epipolar rectification, to generate rectified image 104. The computing system may determine disparity map 106 based on two rectified images (e.g., rectified image 104 and another image captured from another point within the same scene). The computing system may determine a depth map of the scene based on disparity map 106. Additionally, the computing system may make driving, path-planning, and/or navigation determinations based on the depth map.

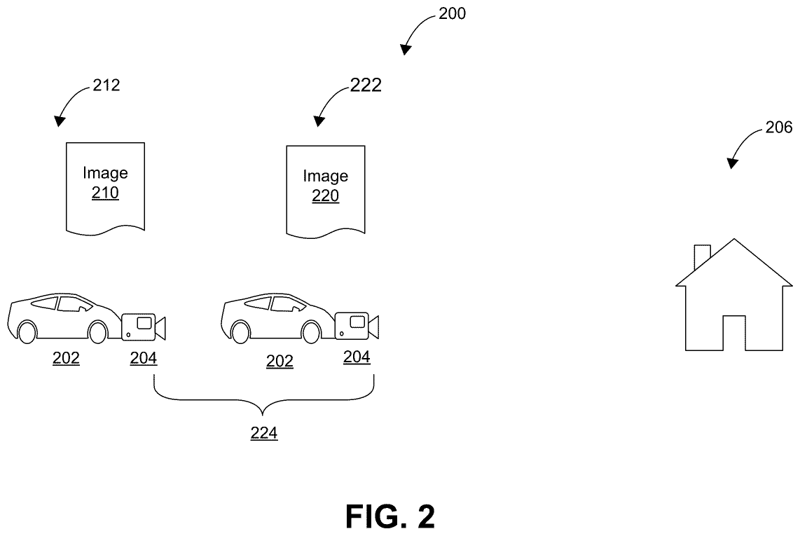

FIG. 2 is a diagram of an example system 200 in which a camera 204 of a vehicle 202 may capture images of a scene 206 from different positions. For example, camera 204 of vehicle 202 may capture image 210 at time 212. Further, camera 204 of vehicle 202 may capture image 220 at time 222. Time 222 may be after time 212. Vehicle 202 may be in a different position at time 212 than vehicle 202 is at time 222. For example, vehicle 202 may move distance 224 between time 212 and time 222.

According to a conventional polar epipolar rectification, image 210 and image 220 may be rectified. For example, initially, image 210 and image 220 may both appear similar to image 102 of FIG. 1. A computing system of vehicle 202 may rectify image 210 and image 220 to generate images that appear similar to rectified image 104 of FIG. 1.

After rectifying image 210 and image 220, the computing system of vehicle 202 may compare pixels along rows of the rectified images to determine disparities between pixels and determine depths of points in scene 206 based on the disparities. For example, the computing system may determine a disparity map similar to disparity map 106 of FIG. 1 based on the rectified versions of image 210 and image 220. In the present disclosure, the term depth may refer to a distance between a system which captured an image and a point in a scene. The computing system of vehicle 202 may determine a respective depth for each of a number of points in scene 206 based on pixels representing the points in scene 206. Additionally, the computing system of vehicle 202 may make driving, path-planning, and/or navigation determinations based on the depth map.

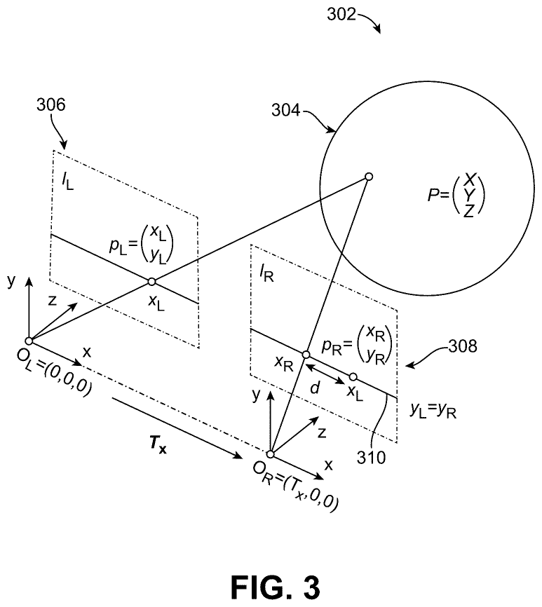

For example, FIG. 3 illustrates two example images that may be used to determine depth information according to a depth-from-stereo (DFS) depth-estimation technique. FIG. 3 illustrates image 306 and image 308 (also denoted in FIG. 3 as image I_{L} and image I_{R}), of a single scene 302 captured from different camera positions, according to various aspects of the present disclosure. The different camera positions are marked as left and right “origin” points, O_{L} and O_{R}, which are offset by a distance Tₓ. In some DFS techniques, image 306 may be captured by a first camera and image 306 may be captured by a second camera. In other DFS techniques, image 306 may be captured by a camera at a first time (e.g., by camera 204 at time 212) and image 308 may be captured by the camera at a second time (e.g., by camera 204 at time 222).

Because of the offset Tₓ, the same point P of object 304 appears at different pixel locations p_{L} and p_{R} within the two images 306 (I_{L}) and 308 (I_{R}). As can be seen, the x-axis coordinate XR in image 308 (I_{R}), corresponding to point PR in image 308 (I_{R}), is offset along epi-polar line 310 by disparity d from a coordinate x_{L} where the coordinate x_{L} corresponds to the position of the point P in the image 306 (I_{L}). This disparity in pixel locations (also referred to as discrepancy) may be used to determine an approximate distance from the cameras to the point P on object 304 in scene 302. By knowing the stereo camera geometry (e.g., the distance between the pair of cameras that captured image 306 and image 308 or the distance the camera traveled between capturing image 306 and image 308) and applying such an analysis to each point in the images, a depth map of the scene may be generated.

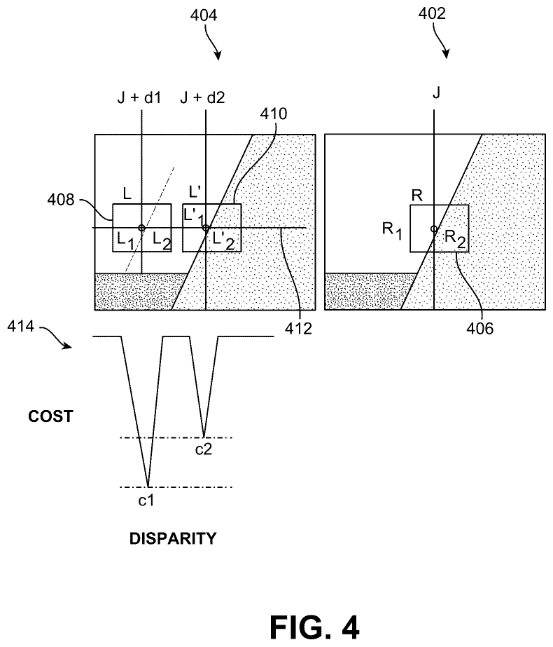

In order to determine the disparity d, a system may determine that the pixel location p_{R} in the image 308 (I_{R}) corresponds to the pixel location p_{L} in the image 306 (I_{L}), for example, by comparing a window of pixels including pixels at, and around, the pixel location p_{L} to a number of windows of pixels in image 308 (I_{R}). An example of such a window-based comparison technique is described with respect to FIG. 4. For example, a DFS system may determine epi-polar line 310 in the image 308 (I_{R}). Epi-polar line 310 may be a defined by a ray projected from origin point O_{L} to the point P as viewed in in the image 306 (I_{R}). The passive stereo-vision system may compare the window of pixels including pixels at, and around, the pixel location p_{L} to similarly-sized windows along epi-polar line 310.

FIG. 4 illustrates two example images, image 402 (which may be a “right image” or a “reference image”) and image 404 (which may be a “left image”), and an example associated cost function 414, according to various aspects of the present disclosure. To compare windows between image 402 and image 404, a window 406 of pixels from the image 402 may be selected. Window 406 of pixels from image 402 may be compared to one or more windows of pixels from image 404. In some cases, window 406 may be compared to similarly-sized windows (e.g., all similarly-sized windows) along an epi-polar line 412 of image 404.

The cost function 414 shown in FIG. 4 is representative of a similarity between window 406 and similarly-sized windows along epi-polar line 412 of image 404 as a function of disparity. The similarity between windows may be based on similarities between respective red, green, blue, and/or intensity (or brightness or luminance) values of pixels included in the respective windows. The lower the value of cost function 414 for a particular disparity, the higher the degree of similarity is between window 406 and a window of image 402 at the corresponding disparity. For example, cost function 414 includes two minima, c1 and c2. The minima c1 corresponds to a disparity d1, which corresponds to a comparison between window 406 and candidate window 408 of image 404. The minima c2 corresponds to a disparity d2 which corresponds to a comparison between window 406 and candidate window 410 of image 404.

A disparity map (such as disparity map 106 of FIG. 1) may be a two-dimensional map of disparities. The two-dimensional map may relate to an image (e.g., image 306 of FIG. 3). For instance, a two-dimensional disparity map may include a resolution that is the same (or substantially the same in some cases) as a corresponding image, with a respective disparity value for each pixel of the image. In one illustrative example, a disparity map may be generated by determining a respective disparity for each pixel of a number of pixels (e.g., all, or most, of the pixels) of an image (e.g., by scanning windows across epi-polar lines of a stereoscopically-paired image and determining a disparity for each of the number of pixels). Each value of the disparity map may represent a disparity (e.g., disparity d of FIG. 3). A depth map may be derived from a disparity map based on the three-dimensional geometry of a scene (e.g., scene 302 of FIG. 3) including a distance between the cameras which captured the images (e.g., the distance T_{X} of FIG. 3).

A depth map may be a representation of three-dimensional information (e.g., depth information). For example, a depth map may be a two-dimensional map of values (e.g., pixel values) representing depths. The values of the depth map may correspond to pixels in a corresponding image (e.g., image 306 of FIG. 3). For instance, the depth map may have a resolution that is the same or substantially the same as the corresponding image, with each depth value of the depth map representing a depth, or distance, between an origin point (e.g., origin point O_{L} of FIG. 3) and points (e.g., point P of FIG. 3). In some cases, each pixel in the depth map may have one depth value. Because a depth map is based on a disparity map, in some cases, each pixel of a disparity may have one disparity.

One advantage of polar epipolar rectification is that polar epipolar rectification rectifies an image such that each row of the rectified image includes pixels sampled from along an epipolar line of the input image. With rows corresponding to epipolar lines, apparent motion of points between image frames is horizontal.

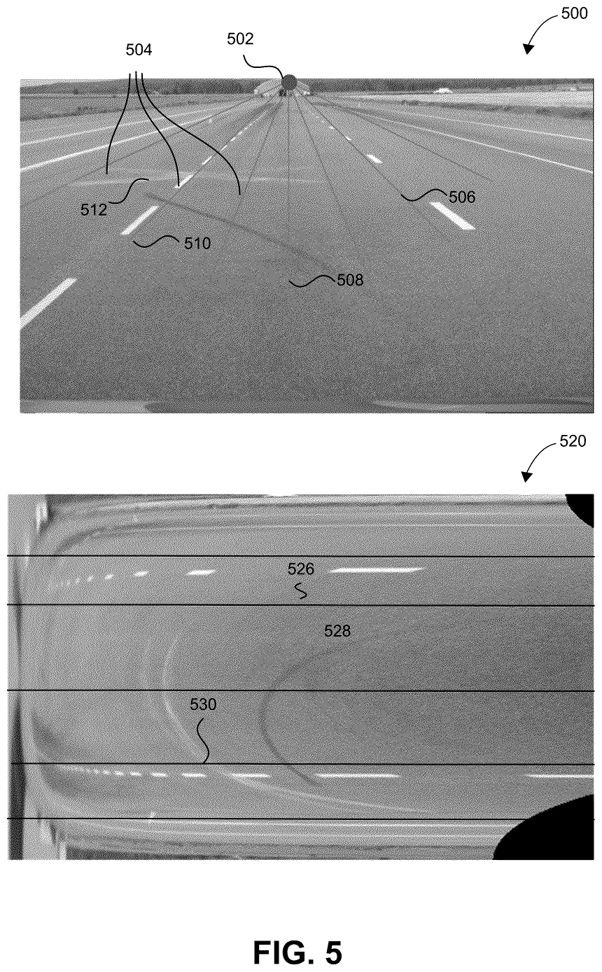

For example, FIG. 5 includes an example image 500 (e.g., image 102 of FIG. 1) overlaid with epipolar lines 504. Additionally, FIG. 5 includes an example rectified image 520 (e.g., rectified image 104 of FIG. 1) overlaid with lines to indicate rows. Each row of pixels of rectified image 520 may include pixels sampled along a corresponding epipolar line of image 500. For example, pixels of row 526 may be sampled from epipolar line 506, pixels of row 528 may be sampled from epipolar line 508, and pixels from row 530 may be sampled from epipolar line 510.

With each row of a rectified image including pixels sampled from along an epipolar line, to determine disparity, pixels from one row of a rectified image can be compared with pixels of a corresponding row of another rectified image. For example, camera 204 of vehicle 202 may capture image 210 and image 220 and rectify image 210 and image 220 to generate rectified images. To determine a disparities between the two rectified images, a computing system may compare (e.g., as described with regard to FIG. 3) pixels from a row of one rectified image with pixels from a corresponding row of the other rectified image. Comparing only along rows may limit the space to search for matching pixels, which may conserve computational resources (e.g., power and/or computing time).

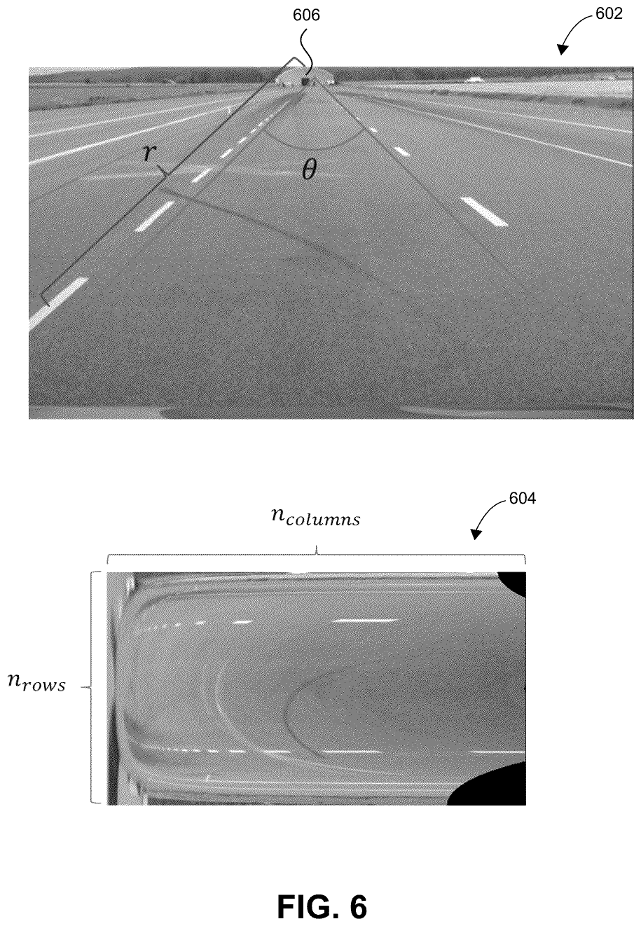

FIG. 6 includes an example image 602 and an example rectified image 604 to provide context for a description of polar epipolar rectification. For example, polar epipolar rectification may include resampling image 602 according to polar coordinates and equations.

Image 602 is overlaid with an indication of angle θ. Angle θ may represent an angle measured from a horizon. Angle θ may be measured from epipole point 606. Additionally, image 602 is overlaid with an indication of radius r—a radial distance from epipole point 606. Each pixel in image 602 may be described by polar coordinates angle θ and radius r.

Pixel of rectified image 604 may be sampled from image 602. For example, according to conventional polar epipolar rectification, pixels of a row of rectified image 604 may be sampled from an epipolar line at a given angle θ at a given radius r. In conventional polar epipolar rectification, the relationship between pixels of rectified image 604 and pixels of image 602 may be described by:

$$sample = ( cos ( θ ) r , sin ( θ ) r )$$

$$θ = f ( row ) = {θ}_{max} \cdot ( \frac{row}{{n}_{r o w s}} - \frac{1}{2} ) + \frac{π}{2}$$

$$r = g ( column ) = {r}_{max} \cdot \frac{column}{{n}_{c o l u m n s}}$$

Where, for example:

$$the number of rows of rectified image 604 - {n}_{r o w s} = 351 ;$$

$$the number of columns of rectified image 604 - {n}_{c o l u m n s} = 600 ;$$

$$0 \leq {θ}_{max} \leq π ; and$$

$$0 \leq {r}_{max} \leq distance to epipole .$$

As mentioned previously, one advantage of polar epipolar rectification is that polar epipolar rectification rectifies an image such that each row of the rectified image includes pixels sampled from along an epipolar line of the input image. With rows corresponding to epipolar lines, apparent motion of points between image frames is horizontal.

However, conventional polar epipolar rectification introduces some drawbacks for automotive use cases. For example, conventional polar epipolar rectification introduces the following flaws into rectified images: 1) conventional polar epipolar rectification produces heavily distorted images which makes it inefficient to search for vertical gradients in the depth map; 2) the ego lane (e.g., the lane in which the vehicle is travelling) will be overrepresented in images rectified according to conventional polar epipolar rectification, this results in loss of crucial information in neighboring lanes; and 3) images rectified according to conventional polar epipolar rectification includes a disproportionate number of samples near the vehicle, this makes it even more difficult to calculate the depth to points distant from the vehicle.

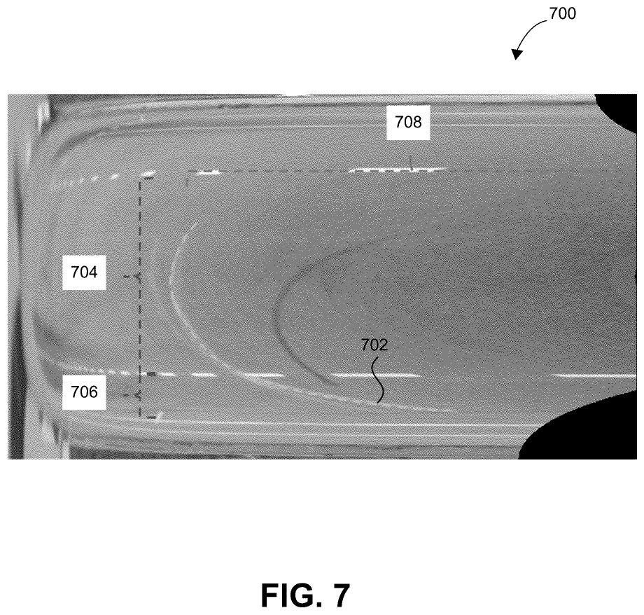

For example, FIG. 7 includes an example rectified image 700 (e.g., rectified image 104 of FIG. 1) overlaid with annotations to indicate flaws introduced by conventional polar epipolar rectification. For example, rectified image 700 is distorted such that lines that are straight in the real world (e.g., lines 512 of FIG. 5) are curved in rectified image 700 (e.g., line 702 of FIG. 7).

Additionally, ego lane 704 is overrepresented in rectified image 700. For example, approximately 50% of the rows of rectified image 700 represent the ego lane. In contrast relatively few rows of rectified image 700 represent left lane 706.

Additionally, a disproportionate number of columns of rectified image 700 represent points in the scene that are close to the vehicle. For example, over 50% of the columns of rectified image 700 represent points that are less than 25 meters from the vehicle, as indicated by close range 708.

In the present disclosure, the term “row” generally refers to pixels along a horizontal line of an image (e.g., a rectified image) and the term “column” generally refers to pixels along a vertical line of an image. In the present disclosure, the choice of rows and columns of a rectified image is arbitrary. In some aspects, rows and columns of a rectified image may be swapped.

The systems and techniques include techniques for addressing each of the identified flaws of conventional polar epipolar rectification. In general, the systems and techniques alter how polar epipolar rectification samples pixels of input images along epipolar lines to generate rectified images. The systems and techniques sample the input image to implement a desired relationship between pixels of an input image and pixels of a rectified image.

The systems and techniques include a distance-alignment technique that may address distortion (e.g., as illustrated by the comparison between lines 512 and line 702), an angle-step technique that may address the overrepresentation of the ego lane (e.g., as illustrated by the comparison between the number of rows of rectified image 700 that represent ego lane 704 to the number of rows of rectified image 700 that represent left lane 706), and a radius-sampling technique that may address the overrepresentation of points close to the vehicle (e.g., as illustrated by the number of columns of rectified image 700 that represent close range 708).

The systems and techniques may implement any or all of the distance-alignment technique, the angle-step technique, and/or the radius-sampling technique. For example, in some aspects, the systems and techniques may include one or two of the distance-alignment technique, the angle-step technique, and/or the radius-sampling technique. In other aspects, the systems and techniques may include all of the distance-alignment technique, the angle-step technique, and/or the radius-sampling technique.

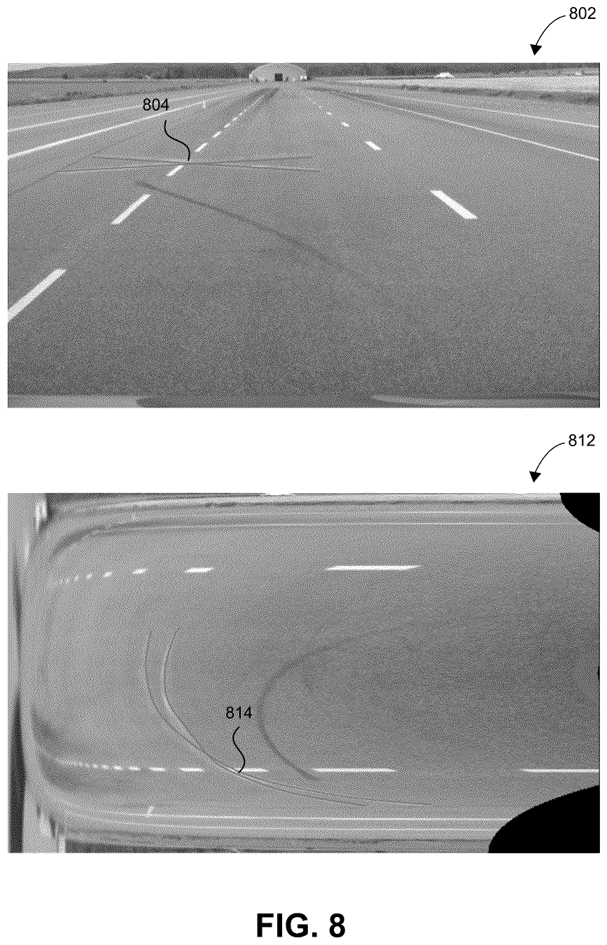

FIG. 8 includes an example image 802 and an example rectified image 812 (e.g., rectified according to conventional polar epipolar rectification) to illustrate distortions caused by conventional polar epipolar rectification. Image 802 includes an annotation indicating lines 804. In the real world, lines 804 are straight. Lines 804 appear straight in image 802. Rectified image 812 may be a rectified version of image 802. In rectified image 812, lines 814 are not straight.

Conventional polar epipolar rectification may cause a column in a rectified image to correspond to a radial distance from the epipole point. For example, lines 814 may be curved in rectified image 812 based on each column of rectified image 812 corresponding to a radial distance the epipole point.

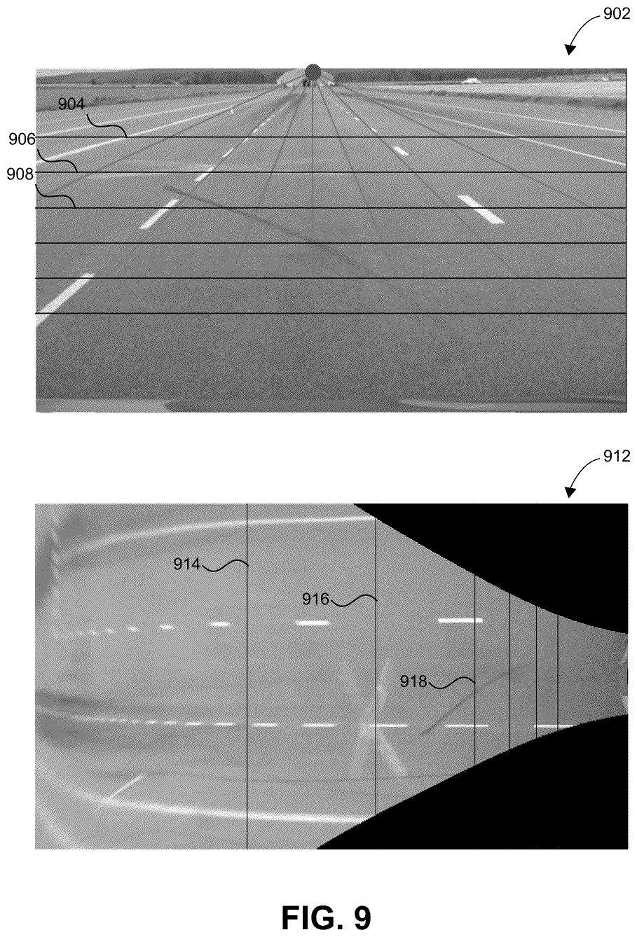

The distance-alignment technique, according to various aspects of the present disclosure, may cause pixels of a same column of a rectified image to correspond to the same row in the original image. FIG. 9 includes an example image 902 and an example rectified image 912 (e.g., rectified according to various aspects of the present disclosure) to illustrate corrections based on the distance-alignment technique.

For example, the distance-alignment technique may sample pixels from row 904 of image 902 to obtain pixels of column 914 of rectified image 912. Similarly, the distance-alignment technique may sample pixels from row 906 to obtain pixels of column 916 and pixels from row 908 to obtain pixels of column 918.

The distance-alignment technique may divide the radius r by the cosine of the angle between the epipolar line and the horizontal axis. This may cause each column in the rectified image to correspond to a single row in the original image rather than being sampled with respect to the distance from the epipole point. This minimizes distortion and optimizes horizontal calculations.

Pixel of rectified image 912 may be sampled from image 902. For example, according to the distance-alignment technique (according to various aspects of the present disclosure), pixels of a row of rectified image 912 may be sampled from an epipolar line at a given angle θ at a given radius r. According to the distance-alignment technique, the relationship between pixels of rectified image 912 and pixels of image 902 may be described by:

$$sample = ( cos ( θ ) r , sin ( θ ) r )$$

$$θ = f ( row ) = {θ}_{max} \cdot ( \frac{row}{{n}_{r o w s}} - \frac{1}{2} ) + \frac{π}{2}$$

$$r = g ( column ) = \frac{{r}_{max} \cdot \frac{column}{{n}_{c o l u m n s}}}{( cos ( θ - \frac{π}{2} )}$$

Where, for example:

$$the number of rows of rectified image 604 - {n}_{rows} = 351 ;$$

$$the number of columns of rectified image 604 - {n}_{columns} = 600 ;$$

$$0 \leq {θ}_{max} < π ; and$$

$$0 \leq {r}_{max} \leq distance to epipole .$$

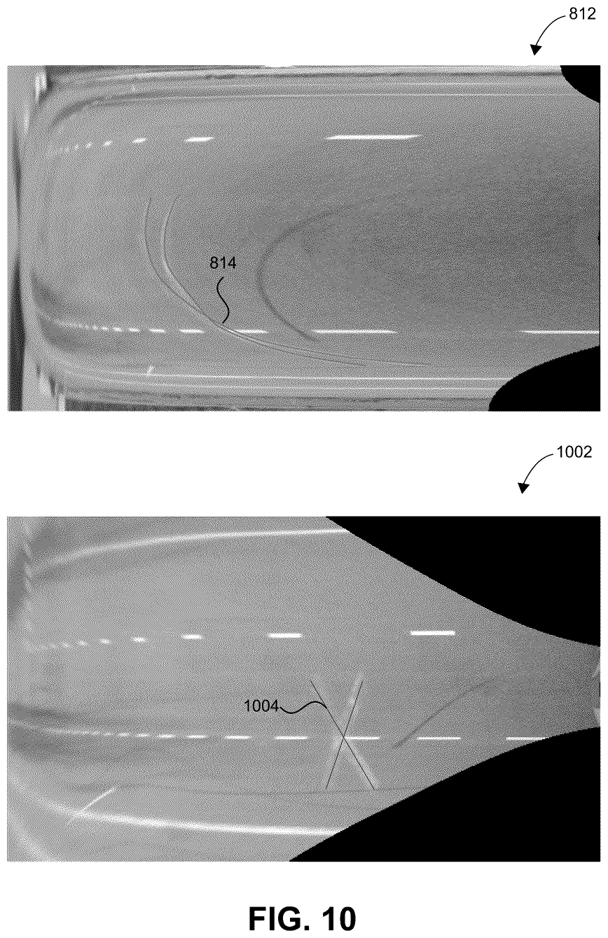

FIG. 10 includes an example rectified image 812 (e.g., rectified according to conventional polar epipolar rectification) and an example rectified image 1002 (e.g., rectified according to the distance-alignment technique) to illustrate how the distance-alignment technique corrects a flaw of conventional polar epipolar rectification. Rectified image 812 includes an annotation indicating lines 814. In the real world, lines 814 are straight. Lines 814 appear curved in rectified image 812. Based on the distance-alignment technique having sampled the input image (e.g., image 802 of FIG. 8) such that each column in the rectified image corresponds to a row in the original image, lines 1004 may be straight in rectified image 1002. Thus, the distance-alignment technique corrects distortions caused by conventional polar epipolar rectification.

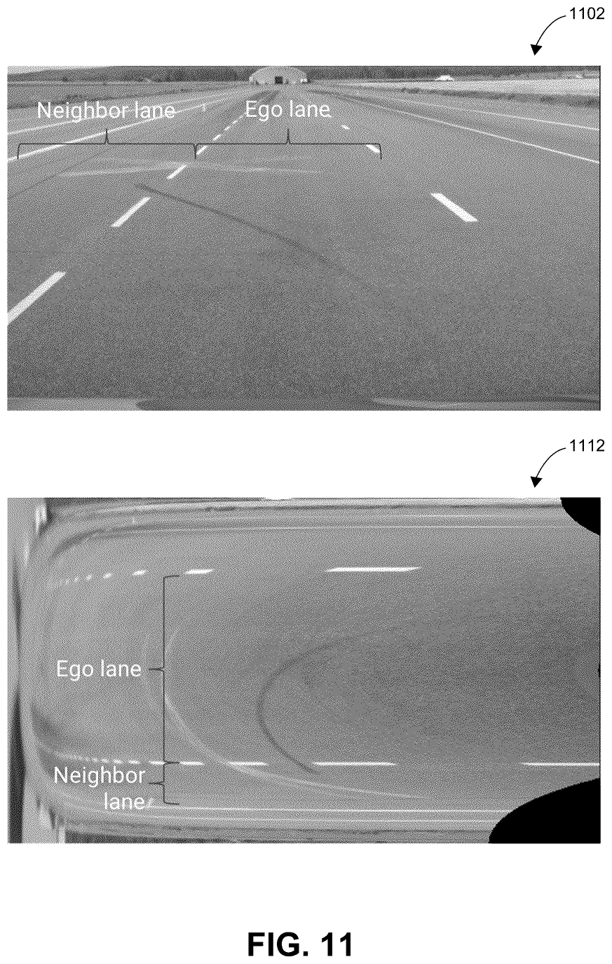

FIG. 11 includes an example image 1102 and an example rectified image 1112 (e.g., rectified according to conventional polar epipolar rectification) to illustrate distortions caused by conventional polar epipolar rectification. Image 1102 includes an annotation indicating portions of image 1102 that represent an ego lane (e.g., a lane from which image 1102 was captured) and portions of image 1102 that represent a neighbor lane (e.g., a lane adjacent to the ego lane). Additionally, rectified image 1112 includes an indication of rows of rectified image 1112 that represent the ego lane and rows of rectified image 1112 that represent the neighbor lane. Notably, more than half of rectified image 1112 represents the ego lane. This results in loss of information in neighboring lanes.

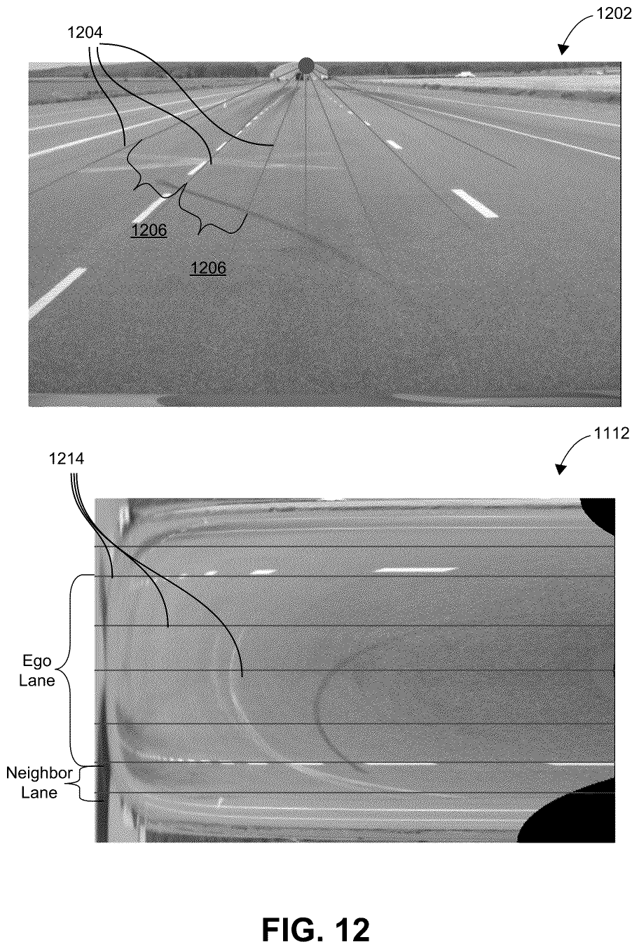

FIG. 12 includes an example input image 1202 overlaid with epipolar lines (e.g., determined according to a conventional polar epipolar rectification) and an example rectified image 1112 overlaid with lines indicating rows corresponding to epipolar lines. For example, FIG. 12 incudes input image 1202 (e.g., an example input image) overlaid with epipolar lines 1204 determined according to a conventional polar epipolar rectification. Epipolar lines 1204 may be evenly angularly spaced. For example, an angular width 1206 between each of epipolar lines 1204 may be the same. As described above, conventional polar epipolar rectification may sample according to:

$$θ = f ( row ) = {θ}_{max} \cdot ( \frac{row}{{n}_{rows}} - \frac{1}{2} ) + \frac{π}{2}$$

Where, for example:

$$the number of rows of rectified image 604 - {n}_{rows} = 351 ; and$$

$$0 \leq {θ}_{max} < π .$$

Because each epipolar line is sampled to generate a row of a rectified image, evenly angularly spaced epipolar lines (e.g., epipolar lines 1204) may result in oversampling in a center of an image (e.g., in columns of the input image near the epipole point). For example, rectified image 1112 is overlaid lines indicating rows 1214 that correspond to epipolar lines 1204. Based on the even angular spacing of epipolar lines 1204 there are more epipolar lines 1204 in an ego lane than in neighboring lanes and thus there are more rows 1214 in rectified image 1112 representing the ego lane than rows 1214 representing the neighbor lane.

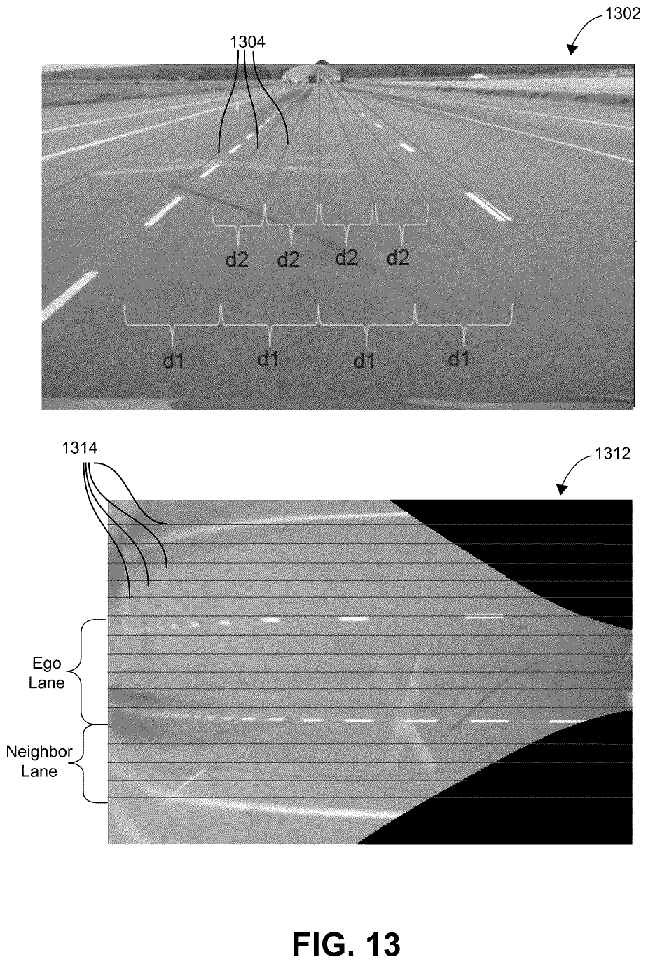

FIG. 13 includes an example image 1302 overlaid with epipolar lines (e.g., determined according to an angle-step technique) and an example rectified image 1312 overlaid with lines indicating rows corresponding to epipolar lines. For example, FIG. 13 incudes image 1302 (e.g., an example input image) overlaid with epipolar lines 1304 determined according to an angle-step technique. Epipolar lines 1304 may be evenly angularly spaced in the physical world. For example, a physical distance 1306 between epipolar lines 1304 may be the same.

The angle-step technique may apply an arctangent/tangent function to the epipolar angle, which effectively distributes the epipolar lines evenly across the image with respect to the horizontal line. This avoids the problem of oversampling near the center of the image, which occurs when the epipolar angle is divided uniformly. For example, the angle-step technique may sample according to:

$$θ = f ( row ) = atan ( 2 tan ( \frac{{θ}_{max}}{2} ) ( \frac{row}{{n}_{rows}} - \frac{1}{2} ) ) + \frac{π}{2}$$

Where, for example:

$$the number of rows of rectified image 604 - {n}_{rows} = 351 ; and$$

$$0 \leq {θ}_{max} < π .$$

According to the angle-step technique, samples from the same column in the rectified image have the same horizontal distance in the input image. For example, according to the angle-step technique, epipolar lines 1304 may be determined such that when each of epipolar lines 1304 are sampled to generate a corresponding row of rows 1314 in a rectified image 1312, each of the rows 1314 are separated by the same pixel distance in image 1302 (for given rows of image 1302). For example, epipolar lines 1304 may be determined such that a pixel distance between two adjacent epipolar lines in image 1302 is the same for given rows of image 1302. For example, each of epipolar lines 1304 may be separated by the same distance d1 at a first given row of image 1302. Further, each of epipolar lines 1304 may be separated by the same distance d2 at a second given row of image 1302. Because each of epipolar lines 1304 is separated by the same pixel distance for a given row, when epipolar lines 1304 are sampled to generate rows of the rectified image, the rows of the rectified image may represent evenly spaced steps in image 1302. Thus, an ego lane may appear as wide in rectified image 1312 as a neighbor lane.

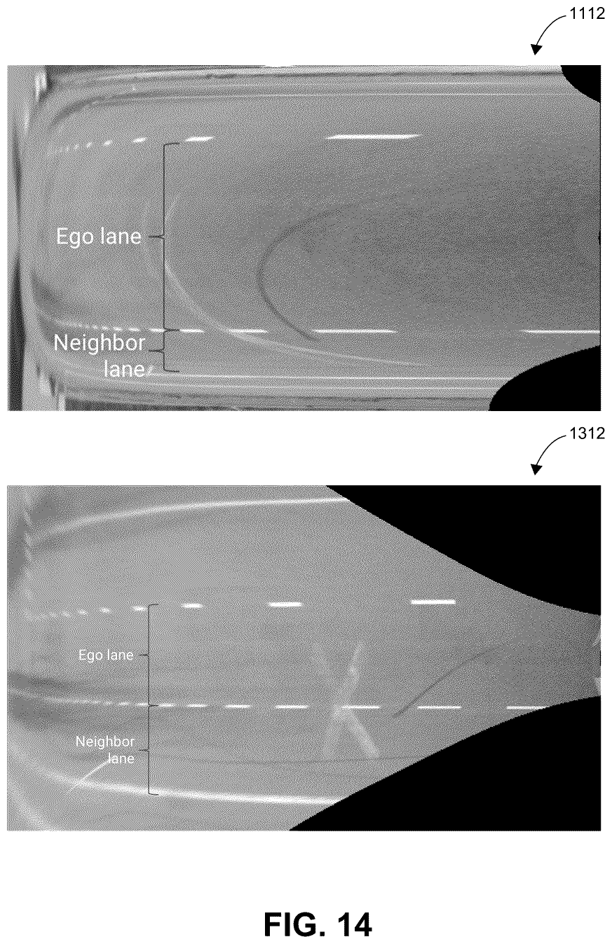

FIG. 14 includes an example rectified image 1112 (e.g., rectified according to conventional polar epipolar rectification) and an example rectified image 1312 (e.g., rectified according to the angle-step technique) to illustrate how the angle-step technique corrects a flaw of conventional polar epipolar rectification. For example, rectified image 1112 includes relatively few pixels representing neighbor lanes whereas rectified image 1312 includes substantially the same number of rows representing the ego lane and the number of rows representing neighbor lanes.

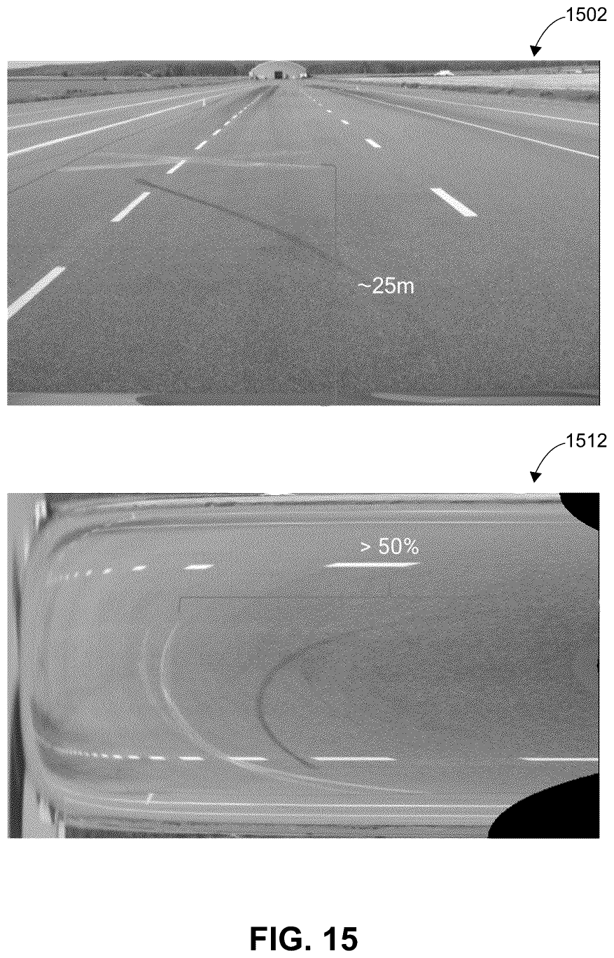

FIG. 15 includes an example input image 1502 and an example rectified image 1512 (e.g., rectified according to conventional polar epipolar rectification) to illustrate distortions caused by conventional polar epipolar rectification. Input image 1502 includes an annotation indicating rows of input image 1502 that represent points in the scene that are within an example distance (e.g., 25 meters (m)) from the camera which captured input image 1502. Additionally, rectified image 1512 includes an indication of columns of rectified image 1512 that represent points of the scene that are within the example distance of from the camera. Notably, more than half of rectified image 1512 represents a distance that is less than 25 meters from the camera. The overrepresentation of close points may make object detection distant from the camera more difficult.

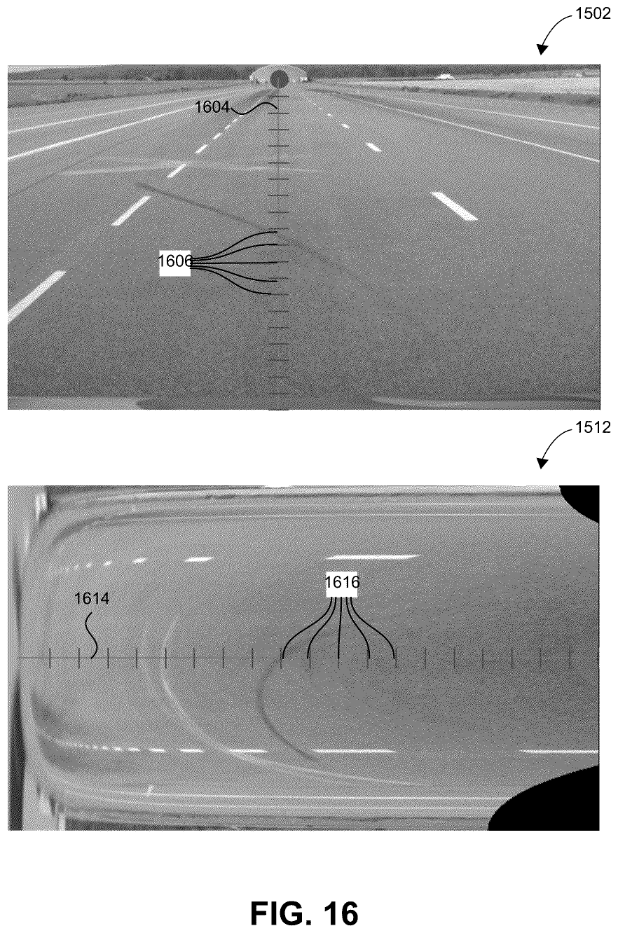

FIG. 16 includes an example input image 1502 and an example rectified image 1512 (e.g., rectified according to conventional polar epipolar rectification). Input image 1502 is overlaid with an example epipolar line 1604 which is marked with points to indicate sampled pixels 1606. For example, epipolar line 1604 may be sampled at sampled pixels 1606. Rectified image 1512 is overlaid with a line to indicate row 1614. Row 1614 may correspond to epipolar line 1604. For example, pixels may be sampled along epipolar line 1604 to generate pixels of pixels 1616. For instance, sampled pixels 1606 may be sampled to generate pixels 1616. As noted with regard to FIG. 15, over half of the columns of rectified image 1512 represent a distance that is less than 25 meters from a camera that captured input image 1502.

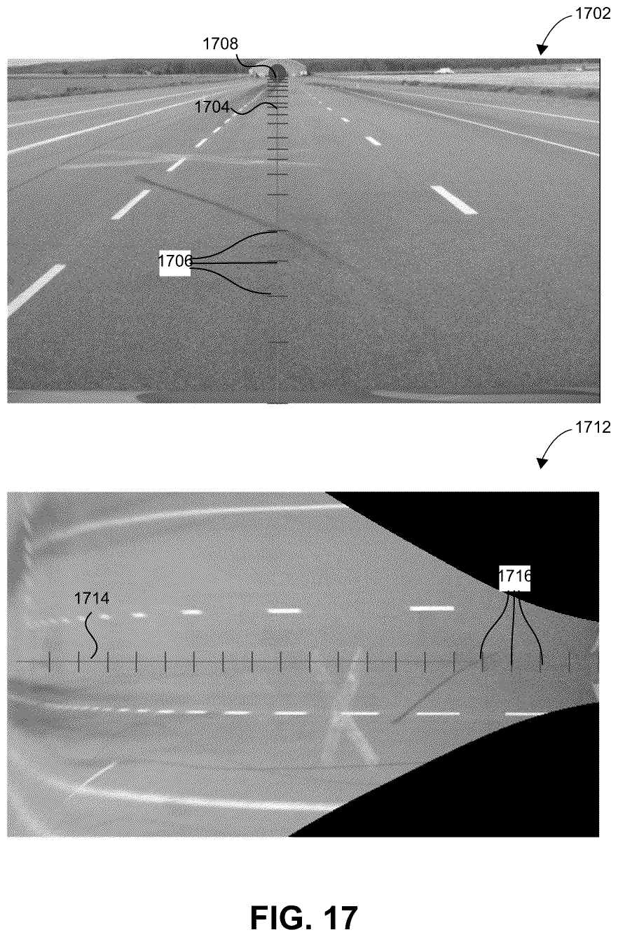

FIG. 17 includes an example image 1702 overlaid with an example epipolar line 1704 (which may be sampled, according to various aspects of the present disclosure) and an example rectified image 1712 overlaid with a line indicating a row corresponding to the example epipolar lines. For example, FIG. 17 incudes image 1702 (e.g., an example input image) overlaid epipolar line 1704 which is marked with points to indicate sampled pixels 1706. For example, epipolar line 1704 may be sampled at sampled pixels 1706. Rectified image 1712 is overlaid with a line to indicate row 1714. Row 1714 may correspond to epipolar line 1704. For example, pixels may be sampled along epipolar line 1704 to generate pixels of row 1714. For instance, sampled pixels 1706 may be sampled to generate pixels 1716.

In contrast to the sampling of sampled pixels 1606 FIG. 16 (e.g., according to the conventional polar epipolar rectification), the sampling of sampled pixels 1706 illustrated in FIG. 17 (e.g., according to a radius-sampling technique) may include oversampling pixels of image 1702 closer to epipolar point 1708 (e.g., farther from the camera that captured image 1702) and undersampling of image 1702 farther from epipolar point 1708. For example, the radius-sampling technique may include using a parabolic function (e.g., a Bezier function) to control the radius sampling. Using a parabolic function may allow for fine-tuning the samples. The parabolic function (e.g., the Bezier function) can be adjusted to densely sample near the epipole where image may be important. Additionally, the parabolic function may result in sparse sampling distant from the epipole (e.g., near the camera that captures image 1702). In some circumstances, losing information close to the camera may be preferable to losing information distant from the camera. The parabolic function may be created such that the radius sampling is a monotonic increasing function, which prevents unnatural distortion of the image. For example, the radius-sampling technique may sample according to:

$$r = g ( column ) = {f}_{bezier} ( column )$$

where, for example n_{columns}=600.

In some case, the radius-sampling technique and the distance-alignment technique may both be implemented. In such cases, the radius-sampling technique and the distance-alignment technique may sample according to:

$$r = g ( column ) = \frac{{f}_{bezier} ( column )}{cos ( θ - \frac{π}{2} )}$$

where, for example, n_{columns}=600.

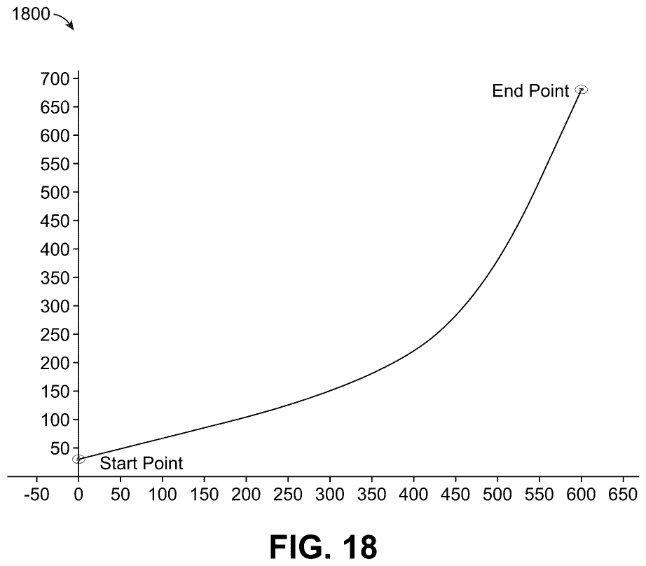

FIG. 18 includes a graph 1800 illustrating an example Bezier function that may be used to determine sampled pixels 1706 along epipolar line 1704, according to various aspects of the present disclosure.

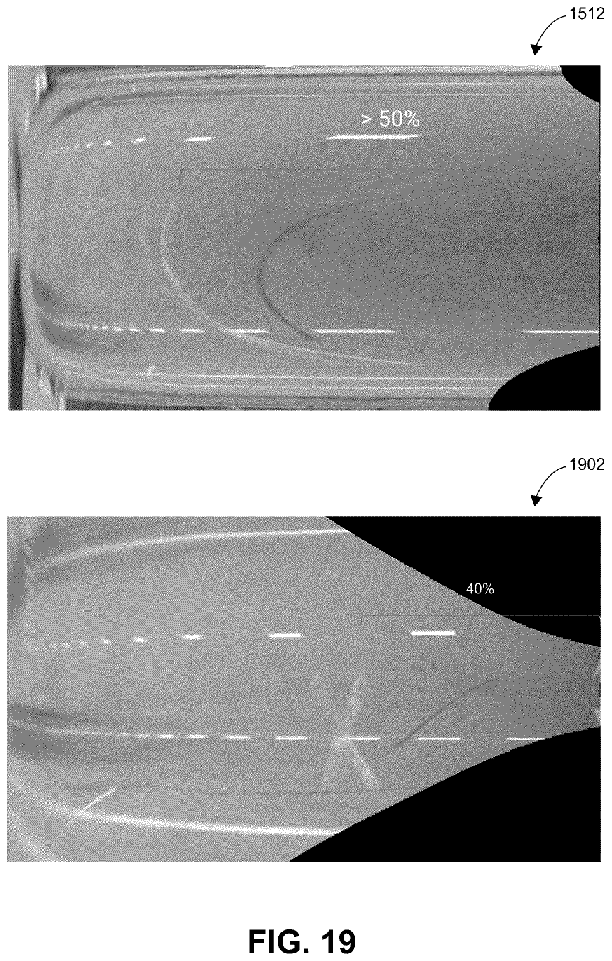

FIG. 19 includes an example rectified image 1512 (e.g., rectified according to conventional polar epipolar rectification) and an example rectified image 1902 (e.g., rectified according to the radius-sampling technique) to illustrate how the radius-sampling technique corrects a flaw of conventional polar epipolar rectification. For example, rectified image 1902 includes more columns representing points close to the epipole point than the number of columns representing points close to the epipole point of rectified image 1512. Additionally, while more than half of the columns of rectified image 1512 represent points within 25 meters from the camera, about 40% of the columns of rectified image 1902 represent point within 25 meters from the camera.

In some cases, all three of the distance-alignment technique, the radius-sampling technique, and the angle-step technique may be implemented together. In such cases, points may be sampled according to:

$$sample = ( cos ( θ ) r , sin ( θ ) r )$$

$$θ = f ( row ) = atan ( 2 tan ( \frac{{θ}_{max}}{2} ) ( \frac{row}{{n}_{rows}} - \frac{1}{2} ) ) + \frac{π}{2}$$

$$r = g ( column ) = \frac{{f}_{bezier} ( column )}{cos ( θ - \frac{π}{2} )}$$

where, for example:

$${n}_{rows} = 351 ;$$

$${n}_{columns} = 600 ;$$

$$0 \leq {θ}_{max} < π ; and$$

$$0 \leq {r}_{max} \leq distance to epipole .$$

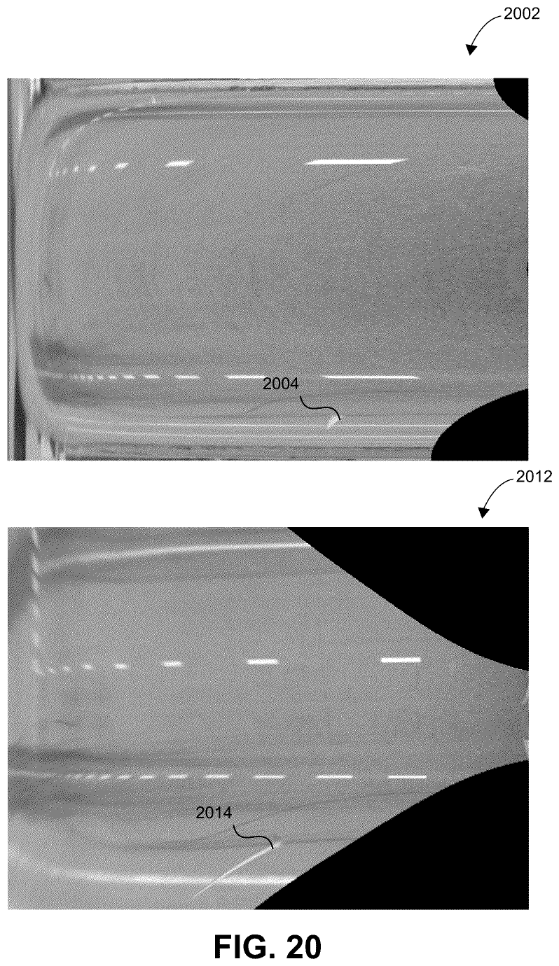

FIG. 20 includes an example rectified image 2002 (e.g., rectified according to conventional polar epipolar rectification) and an example rectified image 2012 (e.g., rectified according to various aspects of the present disclosure).

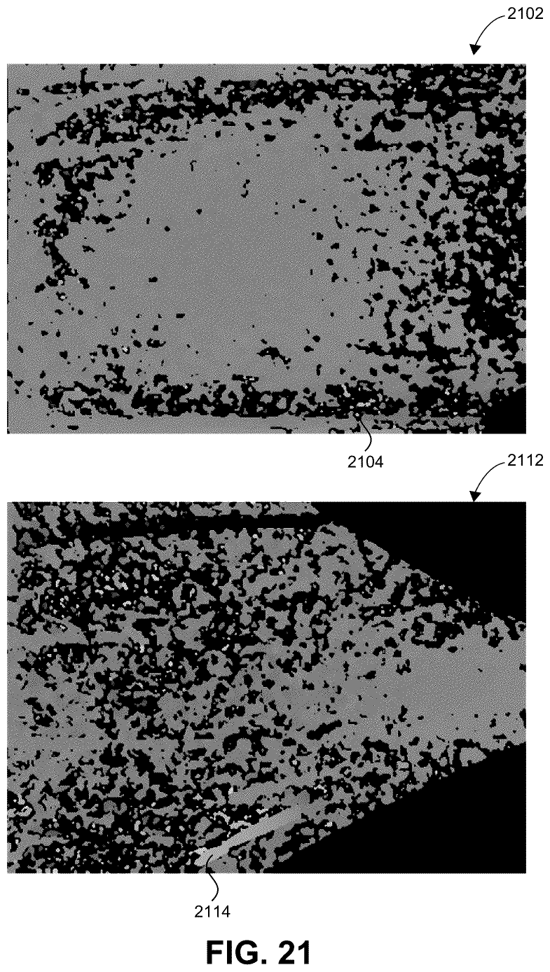

FIG. 21 includes an example disparity map 2102 (which may be generated based on two images rectified according to conventional polar epipolar rectification) and an example disparity map 2112 (which may be based on two images rectified according to various aspects of the present disclosure). For example, disparity map 2102 may be generated based on rectified image 2002 and another similarly rectified image captured from a different position. disparity map 2112 may be generated based on rectified image 2012 and another similarly rectified image captured from a different position.

The scene includes an object in the neighbor lane. The object appears as object 2004 in rectified image 2002, as object 2014 in object 2004, as object 2104 in disparity map 2102 and, as object 2114 in disparity map 2112. Object 2114 is more distinct than object 2104. It may be easier to detect, track, and make determinations based on the appearance of the object in disparity map 2112 (e.g., object 2114) than based on the appearance of the object in disparity map 2102 (e.g., object 2104). This comparison illustrates that the systems and techniques may generate images that improve the performance of downstream tasks compared to conventional polar epipolar rectification.

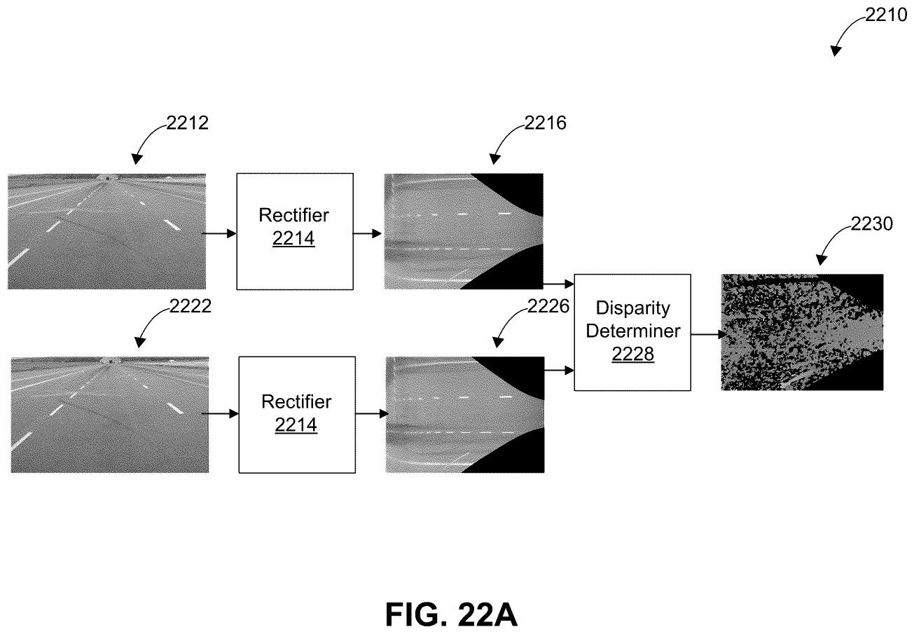

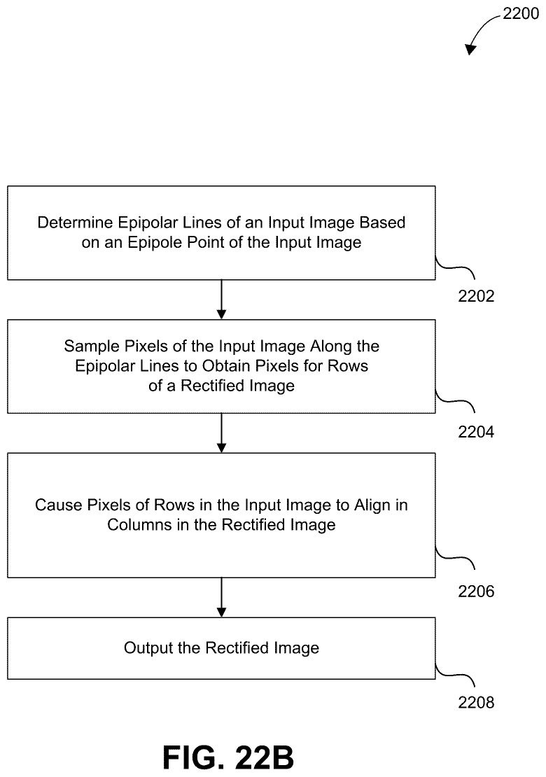

FIG. 22A is a block diagram illustrating an example system 2210 for processing image data, in accordance with aspects of the present disclosure. For example, a rectifier 2214 of system 2210 may process image 2212 to generate rectified image 2216. Image 2212 may be a first image, captured at a first time, for example, from a first position within an environment. Image 2212 may be an example of image 210 of FIG. 2. Rectifier 2214 may process image 2212 according to any or all of the distance-alignment technique, the angle-step technique, and/or the radius-sampling technique, according to various aspects of the present disclosure, to generate rectified image 2216.

Additionally, rectifier 2214 of system 2210 may process image 2222 to generate rectified image 2226. Image 2222 may be a second image, captured at a second time, for example, from a second position within an environment. Image 2222 may be an example of image 220 of FIG. 2. Rectifier 2214 may process image 2222 according to any or all of the distance-alignment technique, the angle-step technique, and/or the radius-sampling technique, according to various aspects of the present disclosure, to generate rectified image 2226.

A disparity determiner 2228 of system 2210 may process rectified image 2216 and rectified image 2226 to generate disparity map 2230. For example, disparity determiner 2228 may match features of rectified image 2216 with features of rectified image 2226 and determine a disparity between the features of rectified image 2216 and the features as the features appear in rectified image 2226. For instance, disparity determiner 2228 may determine a number of pixels that the features changed between rectified image 2216 and rectified image 2226. Disparity determiner 2228 may determine the disparities by comparing rows of rectified image 2216 corresponding rows of rectified image 2226. Disparity map 2230 represents disparities between rectified image 2216 and rectified image 2226 as determined by disparity determiner 2228.

FIG. 22B is a flow diagram illustrating an example process 2200 for processing image data, in accordance with aspects of the present disclosure. One or more operations of process 2200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 2200. The one or more operations of process 2200 may be implemented as software components that are executed and run on one or more processors.

At block 2202, a computing device (or one or more components thereof) may determine epipolar lines of an input image based on an epipole point of the input image. For example, a computing system of vehicle 202 (e.g., which may include system 2210) may determine epipolar lines 504 of image 500 based on an epipolar point 502 of image 500.

At block 2204, the computing device (or one or more components thereof) may sample pixels of the input image based on the epipolar lines to obtain pixels for rows of a rectified image. For example, the computing system of vehicle 202 (e.g., which may include system 2210) may sample pixels of image 500 based on epipolar lines 504 to obtain pixels for rows of rectified image 520.

At block 2206, the computing device (or one or more components thereof) may cause pixels of rows in the input image to align in columns in the rectified image. For example, the computing system of vehicle 202 (e.g., which may include system 2210) may sample pixels from image 500 such that pixels of rows of image 500 align in columns in rectified image 520. For example, the computing system of vehicle 202 may sample pixels of image 902 along epipolar lines (e.g., pixels coincident on the epipolar lines) such that pixels from rows of image 902 (e.g., row 904, row 906, and row 908) align in columns of rectified image 912 (e.g., column 914, column 916, and column 918).

In some aspects, the computing device (or one or more components thereof) may, while sampling pixels along an epipolar line, map the pixels along the epipolar line to a row of the rectified image using a trigonometric function based on an angle of the epipolar line. For example, according to the distance-alignment technique (according to various aspects of the present disclosure), the computing device of vehicle 202 may sample pixels of a row of rectified image 912 from an epipolar line at a given angle θ at a given radius r. According to the distance-alignment technique, the relationship between pixels of rectified image 912 and pixels of image 902 may be described by:

$$sample = ( cos ( θ ) r , sin ( θ ) r )$$

$$θ = f ( row ) = {θ}_{max} \cdot ( \frac{row}{{n}_{rows}} - \frac{1}{2} ) ) + \frac{π}{2}$$

$$r = g ( column ) = \frac{{r}_{max} \cdot \frac{column}{{n}_{columns}}}{cos ( θ - \frac{π}{2} )}$$

Where, for example:

$$the number of rows of rectified image 604 - {n}_{rows} = 351 ;$$

$$the number of columns of rectified image 604 - {n}_{columns} = 600 ;$$

$$0 \leq {θ}_{max} < π ; and$$

$$0 \leq {r}_{max} \leq distance to epipole .$$

In some aspects, the computing device (or one or more components thereof) may, while sampling the pixels of the input image, cause rows of the rectified image to relate to evenly-spaced points in a scene depicted by the input image. For example, the computing system of vehicle 202 may determine epipolar lines 1304 such that when the computing system of vehicle 202 samples along epipolar lines 1304 to obtain pixels of corresponding rows 1314, each of the rows 1314 are separated by the same pixel distance in image 1302 (for given rows of image 1302). For example, epipolar lines 1304 may be determined such that a pixel distance between two adjacent epipolar lines in image 1302 is the same for given rows of image 1302. For example, each of epipolar lines 1304 may be separated by the same distance d1 at a first given row of image 1302. Further, each of epipolar lines 1304 may be separated by the same distance d2 at a second given row of image 1302.

In some aspects, the epipolar lines are determined to be evenly distributed across the input image. For example, the computing system of vehicle 202 may determine epipolar lines 1304 such that epipolar lines 1304 are evenly distributed across image 1302. For example, the computing system of vehicle 202 may determine epipolar lines 1304 such that when the computing system of vehicle 202 samples along epipolar lines 1304 to obtain pixels of corresponding rows 1314, each of the rows 1314 are separated by the same pixel distance in image 1302 (for given rows of image 1302). For example, epipolar lines 1304 may be determined such that a pixel distance between two adjacent epipolar lines in image 1302 is the same for given rows of image 1302. For example, each of epipolar lines 1304 may be separated by the same distance d1 at a first given row of image 1302. Further, each of epipolar lines 1304 may be separated by the same distance d2 at a second given row of image 1302.

In some aspects, the computing device (or one or more components thereof) may determine angles between the epipolar lines based on a trigonometric function. For example, the computing system of vehicle 202 may, according to the angle-step technique, apply an arctangent/tangent function to the epipolar angle, which may effectively distributes the epipolar lines evenly across the image with respect to the horizontal line. For example, the angle-step technique may sample according to:

$$θ = f ( row ) = atan ( 2 tan ( \frac{{θ}_{max}}{2} ) ( \frac{row}{{n}_{rows}} - \frac{1}{2} ) ) + \frac{π}{2}$$

Where, for example:

$$the number of rows of rectified image 604 - {n}_{rows} = 351 ; and$$

$$0 \leq {θ}_{max} < π .$$

In some aspects, the computing device (or one or more components thereof) may, while sampling the pixels of the input image, sample pixels along an epipolar line based on a distance between sampled pixels of the input image and the epipole point. For example, the computing system of vehicle 202 may sample pixels sampled pixels 1706 along epipolar line 1704 based on a distance between sampled pixels 1706 and an epipolar point 1708.

In some aspects, the computing device (or one or more components thereof) may, while sampling the pixels of the input image, sample pixels along an epipolar line based on a Bezier function of a distance between sampled pixels of the input image and the epipole point. For example, the computing system of vehicle 202 may sample sampled pixels 1706 along epipolar line 1704 based on a Bezier function (e.g., as illustrated by graph 1800 of FIG. 18) of a distance between sampled pixels 1706 and epipolar point 1708. The Bezier function may be created such that the radius sampling is a monotonic increasing function, which prevents unnatural distortion of the image. For example, the radius-sampling technique may sample according to:

$$r = g ( column ) = {f}_{bezier} ( column )$$

where, for example n_{columns}=600.

In some case, the radius-sampling technique and the distance-alignment technique may both be implemented. In such cases, the radius-sampling technique and the distance-alignment technique may sample according to:

$$r = g ( column ) = \frac{{f}_{bezier} ( column )}{cos ( θ - \frac{π}{2} )}$$

where, for example, n_{columns}=600.

At block 2208, the computing device (or one or more components thereof) may output the rectified image. For example, the computing system of vehicle 202 (e.g., which may include system 2210) may output rectified image 520.

In some aspects, the computing device (or one or more components thereof) may determine disparities between pixels of the rectified image and pixels of an additional rectified image, wherein the disparities are determined along rows of the rectified image and corresponding rows of the additional rectified image; and determine depths to points in a scene depicted by the input image based on the disparities. For example, the computing system of vehicle 202 may rectify a first image (e.g., image 210) (e.g., according to process 2200) and a second image (e.g., image 220) (e.g., according to process 2200). The computing system of vehicle 202 may determine disparities between pixels of the image 210 and corresponding pixels of image 220. The computing device (or one or more components thereof) may determine disparities along rows of image 210 and corresponding rows of image 220. Further, the computing system of vehicle 202 may determine depths to points in scene 206 based on the disparities.

In some aspects, the computing device (or one or more components thereof) may adjust an operating parameter of a vehicle based on the depths. For example, the computing system of vehicle 202 may adjust an operating parameter of vehicle 202 based on the depths.

In some aspects, the operating parameter is associated with at least one of a path for the vehicle to travel, a steering parameter for operating steering of the vehicle, an automatic-braking parameter for operating one or more brakes of the vehicle, a lane-change parameter for causing the vehicle to navigate from a first lane to a second lane, or displaying information using a user interface of the vehicle. For example, the computing device of vehicle 202 may adjust a driving, path planning, or other parameter of vehicle 202.

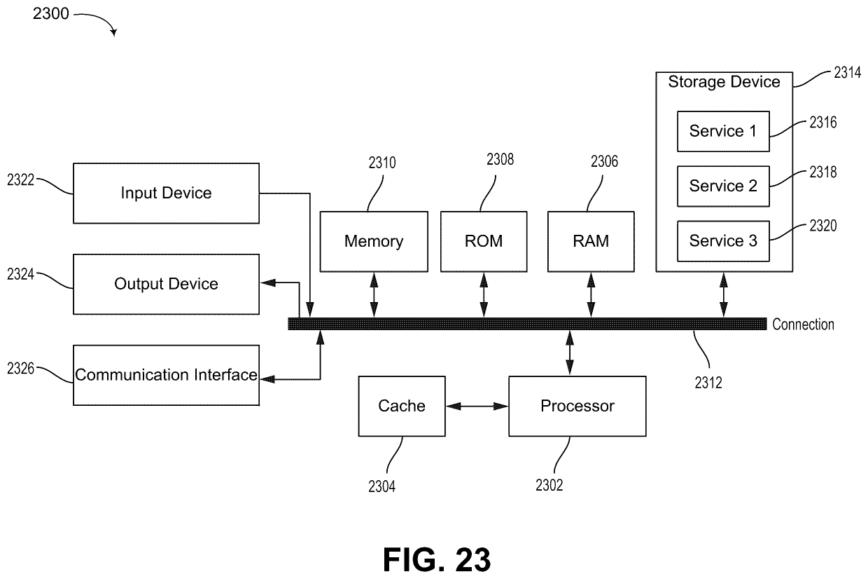

In some examples, as noted previously, the methods described herein (e.g., process 2200 of FIG. 22B, and/or other methods described herein) can be performed, in whole or in part, by a computing device or apparatus. In one example, one or more of the methods can be performed by a computing system of a vehicle, such as vehicle 202 of FIG. 2, system 2210 of FIG. 22A or by another system or device. In another example, one or more of the methods (e.g., process 2200, and/or other methods described herein) can be performed, in whole or in part, by the computing-device architecture 2300 shown in FIG. 23. For instance, a computing device with the computing-device architecture 2300 shown in FIG. 23 can include, or be included in, the components of the computing system of vehicle 202 and/or system 2210 and can implement the operations of process 2200, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

process 2200, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 2200, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 23 illustrates an example computing-device architecture 2300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2300 may include, implement, or be included in the computing system of vehicle 202 of FIG. 2, system 2210 of FIG. 22A and/or other devices, modules, or systems described herein. Additionally or alternatively, computing-device architecture 2300 may be configured to perform process 2200 of FIG. 22B, and/or other process described herein.

The components of computing-device architecture 2300 are shown in electrical communication with each other using connection 2312, such as a bus. The example computing-device architecture 2300 includes a processing unit (CPU or processor) 2302 and computing device connection 2312 that couples various computing device components including computing device memory 2310, such as read only memory (ROM) 2308 and random-access memory (RAM) 2306, to processor 2302.

Computing-device architecture 2300 can include a cache of high-speed memory connected directly with, in close proximity to, or integrated as part of processor 2302. Computing-device architecture 2300 can copy data from memory 2310 and/or the storage device 2314 to cache 2304 for quick access by processor 2302. In this way, the cache can provide a performance boost that avoids processor 2302 delays while waiting for data. These and other modules can control or be configured to control processor 2302 to perform various actions. Other computing device memory 2310 may be available for use as well. Memory 2310 can include multiple different types of memory with different performance characteristics. Processor 2302 can include any general-purpose processor and a hardware or software service, such as service 1 2316, service 2 2318, and service 3 2320 stored in storage device 2314, configured to control processor 2302 as well as a special-purpose processor where software instructions are incorporated into the processor design. Processor 2302 may be a self-contained system, containing multiple cores or processors, a bus, memory controller, cache, etc. A multi-core processor may be symmetric or asymmetric.

To enable user interaction with the computing-device architecture 2300, input device 2322 can represent any number of input mechanisms, such as a microphone for speech, a touch-sensitive screen for gesture or graphical input, keyboard, mouse, motion input, speech and so forth. Output device 2324 can also be one or more of a number of output mechanisms known to those of skill in the art, such as a display, projector, television, speaker device, etc. In some instances, multimodal computing devices can enable a user to provide multiple types of input to communicate with computing-device architecture 2300. Communication interface 2326 can generally govern and manage the user input and computing device output. There is no restriction on operating on any particular hardware arrangement and therefore the basic features here may easily be substituted for improved hardware or firmware arrangements as they are developed.

Storage device 2314 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 2306, read only memory (ROM) 2308, and hybrids thereof. Storage device 2314 can include services 2316, 2318, and 2320 for controlling processor 2302. Other hardware or software modules are contemplated. Storage device 2314 can be connected to the computing device connection 2312. In one aspect, a hardware module that performs a particular function can include the software component stored in a computer-readable medium in connection with the necessary hardware components, such as processor 2302, connection 2312, output device 2324, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for processing image data, the apparatus comprising: at least one memory; and at least one processor coupled to the at least one memory and configured to: determine epipolar lines of an input image based on an epipole point of the input image; sample pixels of the input image based on the epipolar lines to obtain pixels for rows of a rectified image; cause pixels of rows in the input image to align in columns in the rectified image; and output the rectified image.
Aspect 2. The apparatus of aspect 1, wherein the at least one processor is configured to: determine disparities between pixels of the rectified image and pixels of an additional rectified image, wherein the disparities are determined along rows of the rectified image and corresponding rows of the additional rectified image; and determine depths to points in a scene depicted by the input image based on the disparities.
Aspect 3. The apparatus of aspect 2, wherein the at least one processor is configured to adjust an operating parameter of a vehicle based on the depths.
Aspect 4. The apparatus of aspect 3, wherein the operating parameter is associated with at least one of a path for the vehicle to travel, a steering parameter for operating steering of the vehicle, an automatic-braking parameter for operating one or more brakes of the vehicle, a lane-change parameter for causing the vehicle to navigate from a first lane to a second lane, or displaying information using a user interface of the vehicle.
Aspect 5. The apparatus of any one of aspects 1 to 4, wherein the at least one processor is configured to, while sampling pixels along an epipolar line, map the pixels along the epipolar line to a row of the rectified image using a trigonometric function based on an angle of the epipolar line.
Aspect 6. The apparatus of any one of aspects 1 to 5, wherein the at least one processor is configured to, while sampling the pixels of the input image, cause rows of the rectified image to relate to evenly-spaced points in a scene depicted by the input image.
Aspect 7. The apparatus of any one of aspects 1 to 6, wherein the epipolar lines are determined to be evenly distributed across the input image.
Aspect 8. The apparatus of any one of aspects 1 to 7, wherein the at least one processor is configured to determine angles between the epipolar lines based on a trigonometric function.
Aspect 9. The apparatus of any one of aspects 1 to 8, wherein the at least one processor is configured to, while sampling the pixels of the input image, sample pixels along an epipolar line based on a distance between sampled pixels of the input image and the epipole point.
Aspect 10. The apparatus of any one of aspects 1 to 9, wherein the at least one processor is configured to, while sampling the pixels of the input image, sample pixels along an epipolar line based on a Bezier function of a distance between sampled pixels of the input image and the epipole point.
Aspect 11. A method for processing image data, the method comprising: determining epipolar lines of an input image based on an epipole point of the input image; sampling pixels of the input image based on the epipolar lines to obtain pixels for rows of a rectified image; causing pixels of rows in the input image to align in columns in the rectified image; and outputting the rectified image.
Aspect 12. The method of aspect 11, further comprising: determining disparities between pixels of the rectified image and pixels of an additional rectified image, wherein the disparities are determined along rows of the rectified image and corresponding rows of the additional rectified image; and determining depths to points in a scene depicted by the input image based on the disparities.
Aspect 13. The method of aspect 12, further comprising adjusting an operating parameter of a vehicle based on the depths.
Aspect 14. The method of aspect 13, wherein the operating parameter is associated with at least one of a path for the vehicle to travel, a steering parameter for operating steering of the vehicle, an automatic-braking parameter for operating one or more brakes of the vehicle, a lane-change parameter for causing the vehicle to navigate from a first lane to a second lane, or displaying information using a user interface of the vehicle.
Aspect 15. The method of any one of aspects 11 to 14, wherein, while sampling pixels along an epipolar line, mapping the pixels along the epipolar line to a row of the rectified image using a trigonometric function based on an angle of the epipolar line.
Aspect 16. The method of aspect any one of aspects 11 to 15, wherein, while sampling the pixels of the input image, causing rows of the rectified image to relate to evenly-spaced points in a scene depicted by the input image.
Aspect 17. The method of any one of aspects 11 to 16, wherein the epipolar lines are determined to be evenly distributed across the input image.
Aspect 18. The method of any one of aspects 11 to 17, further comprising determining angles between the epipolar lines based on a trigonometric function.
Aspect 19. The method of any one of aspects 11 to 18, further comprising, while sampling the pixels of the input image, sampling pixels along an epipolar line based on a distance between sampled pixels of the input image and the epipole point.
Aspect 20. The method of any one of aspects 11 to 19, further comprising, while sampling the pixels of the input image, sampling pixels along an epipolar line based on a Bezier function of a distance between sampled pixels of the input image and the epipole point.
Aspect 21. A non-transitory computer-readable storage medium having stored thereon instructions that, when executed by at least one processor, cause the at least one processor to perform operations according to any of aspects 11 to 20.
Aspect 22. An apparatus for providing virtual content for display, the apparatus comprising one or more means for perform operations according to any of aspects 11 to 20.

What is claimed is:

1. An apparatus for processing image data, the apparatus comprising:
at least one memory; and
at least one processor coupled to the at least one memory and configured to:
determine epipolar lines of an input image based on an epipole point of the input image;
sample pixels of the input image based on the epipolar lines to obtain pixels for rows of a rectified image;
cause pixels of rows in the input image to align in columns in the rectified image; and
output the rectified image.

2. The apparatus of claim 1, wherein the at least one processor is configured to:
determine disparities between pixels of the rectified image and pixels of an additional rectified image, wherein the disparities are determined along rows of the rectified image and corresponding rows of the additional rectified image; and
determine depths to points in a scene depicted by the input image based on the disparities.

3. The apparatus of claim 2, wherein the at least one processor is configured to adjust an operating parameter of a vehicle based on the depths.

4. The apparatus of claim 3, wherein the operating parameter is associated with at least one of a path for the vehicle to travel, a steering parameter for operating steering of the vehicle, an automatic-braking parameter for operating one or more brakes of the vehicle, a lane-change parameter for causing the vehicle to navigate from a first lane to a second lane, or displaying information using a user interface of the vehicle.

5. The apparatus of claim 1, wherein the at least one processor is configured to, while sampling pixels along an epipolar line, map the pixels along the epipolar line to a row of the rectified image using a trigonometric function based on an angle of the epipolar line.

6. The apparatus of claim 1, wherein the at least one processor is configured to, while sampling the pixels of the input image, cause rows of the rectified image to relate to evenly-spaced points in a scene depicted by the input image.

7. The apparatus of claim 1, wherein the epipolar lines are determined to be evenly distributed across the input image.

8. The apparatus of claim 1, wherein the at least one processor is configured to determine angles between the epipolar lines based on a trigonometric function.

9. The apparatus of claim 1, wherein the at least one processor is configured to, while sampling the pixels of the input image, sample pixels along an epipolar line based on a distance between sampled pixels of the input image and the epipole point.

10. The apparatus of claim 1, wherein the at least one processor is configured to, while sampling the pixels of the input image, sample pixels along an epipolar line based on a Bezier function of a distance between sampled pixels of the input image and the epipole point.

11. A method for processing image data, the method comprising:
determining epipolar lines of an input image based on an epipole point of the input image;
sampling pixels of the input image based on the epipolar lines to obtain pixels for rows of a rectified image;
causing pixels of rows in the input image to align in columns in the rectified image; and
outputting the rectified image.

12. The method of claim 11, further comprising:
determining disparities between pixels of the rectified image and pixels of an additional rectified image, wherein the disparities are determined along rows of the rectified image and corresponding rows of the additional rectified image; and
determining depths to points in a scene depicted by the input image based on the disparities.

13. The method of claim 12, further comprising adjusting an operating parameter of a vehicle based on the depths.

14. The method of claim 13, wherein the operating parameter is associated with at least one of a path for the vehicle to travel, a steering parameter for operating steering of the vehicle, an automatic-braking parameter for operating one or more brakes of the vehicle, a lane-change parameter for causing the vehicle to navigate from a first lane to a second lane, or displaying information using a user interface of the vehicle.

15. The method of claim 11, wherein, while sampling pixels along an epipolar line, mapping the pixels along the epipolar line to a row of the rectified image using a trigonometric function based on an angle of the epipolar line.

16. The method of claim 11, wherein, while sampling the pixels of the input image, causing rows of the rectified image to relate to evenly-spaced points in a scene depicted by the input image.

17. The method of claim 11, wherein the epipolar lines are determined to be evenly distributed across the input image.

18. The method of claim 11, further comprising determining angles between the epipolar lines based on a trigonometric function.

19. The method of claim 11, further comprising, while sampling the pixels of the input image, sampling pixels along an epipolar line based on a distance between sampled pixels of the input image and the epipole point.

20. The method of claim 11, further comprising, while sampling the pixels of the input image, sampling pixels along an epipolar line based on a Bezier function of a distance between sampled pixels of the input image and the epipole point.
